(19) United States
(12) Patent Application Publication
(10) Pub. No.: US 2012/0173705 A1
(43) Pub. Date: Jul. 5, 2012

(54) SYSTEM AND METHOD FOR CONSOLIDATED MONITORING AND MANAGING OF NETWORK ENABLED DEVICES

(75) Inventor: Joaquin Hernandez, Hollywood, FL (US)

(73) Assignee: OPENPEAK INC., Boca Raton, FL (US)

(21) Appl. No.: 12/983,135

(22) Filed: Dec. 31, 2010

(51) Int. Cl. G06F 15/173

(52) U.S. Cl. 709/224

(57) ABSTRACT

A system and method for monitoring and managing a network of electrical devices includes a central device operatively connected to a plurality of end devices by a network, such as a ZigBee network. The central device can monitor the status of the first plurality of end devices and display the status of the end devices. The central device can also be configured to command an aspect of at least one of the first plurality of end devices. Thus, the user can remotely monitor and adjust an aspect of one or more of the end devices by the central device. All end devices connected to the network can be monitored and managed from the central device, thereby improving monitoring of the devices and providing a convenient way to adjust the devices to desired conditions.

### FIELD

Embodiments relate in general to electrical devices and, more particularly, to the monitoring of electrical devices.

### BACKGROUND

Typically, there is a plurality of electrical devices within any home, office, commercial or industrial environment. If a person is interested in determining the status of a particular electrical device, then he or she must personally travel to the device and inspect it. Such actions can be time consuming and tedious. Moreover, there may be instances in which a person is unaware of a problem with one of the devices or may not be able to readily detect the problem. In such instances, some time may pass before the problem is discovered. During this time, greater harm or damage may result than if the problem had been discovered earlier. Thus, there is a need for a system and method that can minimize such concerns.

### SUMMARY

In one respect, embodiments are directed to a system for monitoring and managing a network of electrical devices. The system includes a central device and a first plurality of end devices. The first plurality of end devices is operatively connected to the central device by a first network. The first network can be any suitable network, such as a ZigBee network. The end devices are electrical devices. The central device is configured to monitor the status of the first plurality of end devices. In some instances, the central device can present the status of the first plurality of end devices to a user. The central device is further configured to remotely command at least one aspect of at least one of the first plurality of end devices.

The system can further include a communication device. The central device can be operatively connected to transmit notifications to the communication device. As a result, a user can be notified of a status of at least one of the first plurality of end devices. The communication device can be operatively connected to transmit instructions to the central device. Thus, the user can adjust an aspect of the end device in response to the notification. The communication device can be any suitable device, including, for example, a cellular telephone, a smart phone, a personal digital assistant, a tablet computer, a digital reader, a handheld device having wireless connection capability, a computer, a portable communication device, a portable computing device, an entertainment device or a camera.

In one embodiment, the central device can be configured to remotely adjust one or more aspects of one or more of the first plurality of end devices upon the occurrence of a particular status of that particular end device. Such adjustments can be made automatically. Alternatively or in addition, the central device can be configured to remotely adjust one or more aspects of the first plurality of end devices upon the occurrence of a status of a different one of the first plurality of end devices. Such adjustments can be made automatically.

The central device and the first plurality of end devices can interact in any suitable manner. In one embodiment, the central device can be configured to prompt the first plurality of end devices. The first plurality of end devices can report to the central device in response to the prompts. Alternatively, the first plurality of end devices can report to the central device without prompting from the central device.

In some instances, at least one of the first plurality of end devices can also be a second central device. The second central device can be operatively connected to a second plurality of end devices by a second network. The second network can be separate from the first network. The second central device can be configured to monitor the status of the second plurality of end devices and to report to the first central device. The first central device can be configured to remotely adjust one or more aspects of at least one of the second plurality of end devices. In one embodiment, the second central device can be a smart meter.

In another respect, embodiments are directed to a method of monitoring and managing a first plurality of end devices. The first plurality of end devices is operatively connected to a central device by a network. The central device includes a transceiver for communicating with the first plurality of end devices and a processor. The central device also includes an output system.

According to the method, the status of each of the first plurality of end devices is collected via the central device. The status of each of the first plurality of end devices is presented to a user on the output system. Such presentation can be performed via the processor. The collecting step can be performed on a continuous basis or a periodic basis.

The method can further include the step of notifying a user of a condition of at least one of the first plurality of end devices. The notifying step can be performed in various ways. In one embodiment, the notifying step can comprise transmitting a notification to a communication device operatively connected to the central device. The notifying step can be performed by the processor.

The method can further include the step of commanding one of the first plurality of end devices based on the status of that particular end device. Alternatively, the method can further include the step of adjusting one of the first plurality of end devices based on the status of a different one of the first plurality of end devices.

The method can further including the step of one or more of the end devices automatically reporting the status of each device to the central device. Alternatively or in addition, the method can include the steps of the central device prompting the end devices for a status. The end devices can report their status to the central device in response to the prompt therefrom.

In one embodiment, one of the first plurality of end devices can be a second central device. That is, the end device can be a second central device that is operatively connected to a second plurality of end devices by a second network. The second network can be different from the first network. The second central device can be configured to monitor the status of the second plurality of end devices and to report to the first central device. In such case, the method can further include the step of presenting the status of the second plurality of end devices to a user on the output system. The first central device can be configured to command an aspect the second central device. As a result, the method can further include the step of commanding one of the second plurality of end devices based on an instruction received in the first central device.

### BRIEF DESCRIPTION OF THE DRAWINGS

FIG. 1 is a diagrammatic view of a first system for monitoring and/or managing network enabled devices.

FIG. 2 is a diagrammatic view of a central device of the first system, wherein the central device is a network coordinator.

FIG. 3 is a diagrammatic view of an end device of the first system.

FIG. 4 is a method for monitoring and/or managing network enabled devices.

FIG. 5 is a diagrammatic view of a second system for monitoring and/or managing network enabled devices, wherein one of the end devices of a first network is a central device of a second network.

FIG. 6 is a diagrammatic view of a central device of the second system.

### DETAILED DESCRIPTION

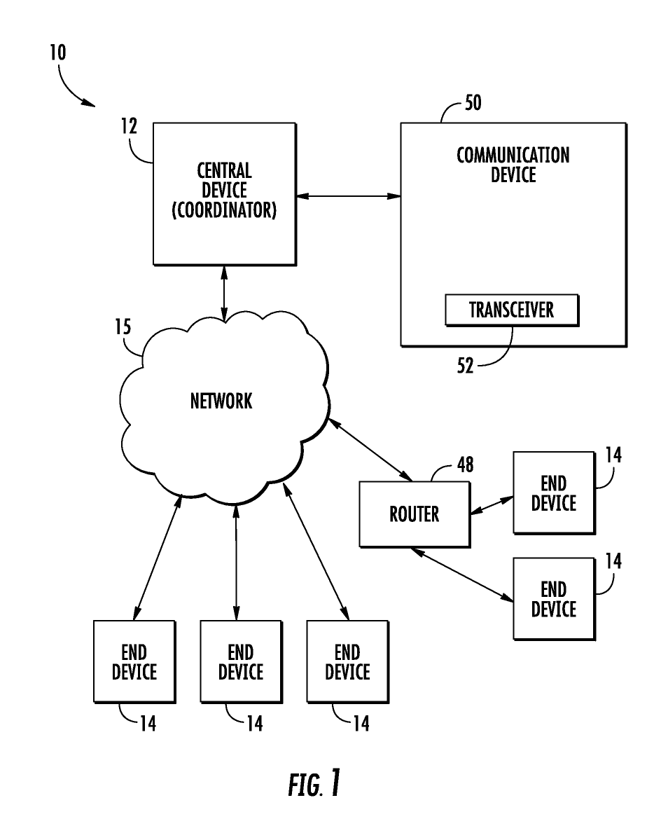

Arrangements described herein relate to systems and methods for monitoring and/or managing devices on a network. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of the Aspects and embodiments herein. Arrangements are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary system 10 for monitoring and/or managing network enabled devices is shown. The system 10 can include a central device 12 and one or more end devices 14 operatively connected to the central device 12 by a network 15. The term “operatively connected” can include direct or indirect connections, including connections without direct physical contact. The term “network” is defined as one or more components designed to transmit and/or receive information from one source to another, including in a centrally-coordinated manner or in a peer-to-peer fashion. The transmission can be achieved in any suitable manner, such as by a hardwire connection or wireles sly. The central device 12 and the end devices 14 will be described in greater detail below.

In one embodiment, the central device 12 can be the coordinator of all end devices 14 operatively connected to it. The central device 12 can be configured to collect the status of all end devices 14 operatively connected to it. The term “collect” is defined as determining, reporting, assembling, gathering and/or inquiring into the status of one or more end devices. The central device 12 can be configured to at least partially command or monitor one or more of the end devices 14 operatively connected thereto. The term “command” is defined as controlling, modifying or adjusting, which may be accomplished in any suitable manner, including by hardware, software or combinations thereof. The central device 12 can be any suitable device including, for example, a computer, a tablet computer, or a laptop computer, just to name a few possibilities. The central device 12 can include any suitable operating system.

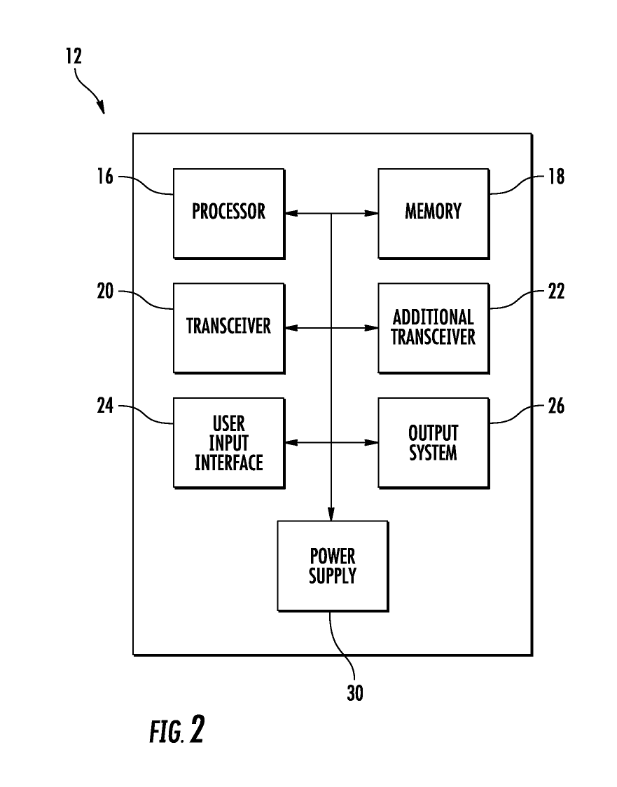

FIG. 2 shows a diagrammatic view of at least some of the components of the central device 12. The central device 12 can include a processor 16. The processor 16 may be implemented with one or more general-purpose and/or special-purpose processors. Examples of suitable processors include microprocessors, microcontrollers, DSP processors, and other circuitry that can execute software.

The central device 12 can include memory 18 for storing various types of data. The memory 18 can include volatile and/or non-volatile memory. Examples of suitable memory 18 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 18 can be operatively connected to the processor 16 for use thereby.

The central device 12 can further include one or more wireless transceivers 20. The wireless transceiver 20 can be operatively connected to the processor 16 and/or the memory 18. Any suitable wireless transceiver can be used to wirelessly access the network 15 to transmit data to and receive data from the end device 14. The transceiver 20 may use any one of a number of wireless technologies. In one embodiment but without limitation, the transceiver 20 can be a ZigBee transceiver. Other suitable transceivers include a cellular transceiver, a broadband internet transceiver, a local area network (LAN) transceiver, a wide area network (WAN) transceiver, a wireless local area network (WLAN) transceiver, a personal area network (PAN) transceiver, a body area network (BAN) transceiver, a WiFi transceiver, a WiMax transceiver, a Bluetooth transceiver, a 3G transceiver, a 4G transceiver, a WirelessHART transceiver, a MiWi transceiver, an IEEE 802.11 transceiver, an IEEE 802.15.4 transceiver, or a Near Field Communication (NFC) transceiver, just to name a few possibilities. The transceiver 20 can include any wireless technology developed in the future. In some embodiments, the central device 12 may include one or more additional wireless transceivers 22 for accessing further wireless networks in addition to or in lieu of those accessed using the wireless transceiver 20.

The central device 12 can include a user input interface 24 for receiving input from a user. Any suitable user input interface 24 can be provided, including, for example, a keypad, display, touch screen, button, joystick, mouse, microphone or combinations thereof. The central device 12 can include an output system 26 for presenting information to the user. The output system 26 can include a display (not shown). The output system 26 can also include an audio interface (not shown) that can include a microphone, earphone and/or speaker (not shown). The central device 12 may include a power supply 30. As is shown in FIG. 2, the processor 16, the memory 18, the transceiver 20, the additional transceiver 22, the user input interface 24, the output system 26 and/or the power supply 30 can be operatively connected to each other in any combination in any suitable manner.

The end device 14 can be any device that is at least partially powered by electrical energy. The end device 14 can be almost any device in a home, office, commercial, industrial or other setting. Examples of various suitable end devices 14 include a refrigerator, microwave, oven, stove, thermostat, toaster, toaster oven, air conditioner, dishwasher, washer, dryer, light, blender, coffee maker, freezer, fan, security system, DVD player, Blu-ray player, set-top box, television, gaming system, radio, stereo, garbage disposal, computer, printer, scanner, lighting, copy machine, fax machine, digital picture frame, hot water heater, vent, space heater, blow dryer, curling iron, camera, surveillance camera, pump, pool pump, pool heater, water sensor, power sensor, smoke detector, carbon monoxide detector, chemical sensor and/or machines. When a plurality of end devices 14 is provided, the end devices 14, in some instances, may not be able to transmit data to or receive data from each other. In such case, the plurality of end devices 14 may be able to communicate with only the central device 12 or through some medium communicating with the central device 12.

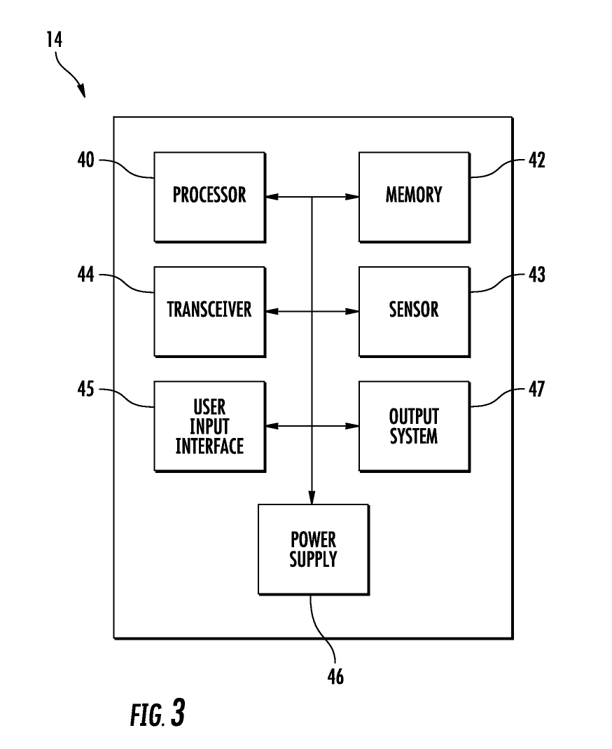

Referring to FIG. 3, an exemplary end device 14 is shown. The end device 14 can include a processor 40. The end device 14 may also include memory 42 for storing various types of data. The memory 42 can be operatively connected to the processor 40 for use thereby. The above-discussion of the processor 16 and memory 18 made in connection with the central device 12 is equally applicable to the processor 16 and memory 18 of the end device 14.

The end device 14 may also include one or more sensors 43 operatively connected thereto. The one or more sensors 43 can be any component or group of components capable of detecting, measuring or quantifying some condition of the end device 14. Examples of possible conditions include whether the device is on or off, remaining battery life, whether the device is open or closed, locked or unlocked, sound level, temperature, temperature changes, flow rate, fluid level, weight, mass, pressure, force, stress, electrical current, magnetic force, humidity, energy consumption rate, light, whether all components or systems are functioning normally or whether there is an issue with some component or system thereof, just to name a few possibilities.

The one or more sensors 43 can be any type of sensor. The quantity and type of sensors 43 used on one of the end devices 14 may or may not be the same as the sensors 43 used on another one of the end devices 14. The sensors 43 can be operatively connected to the processor 40 and/or memory 42. Data from the sensors 43 can be stored to the memory 42. The processor 40 can analyze data from the sensors 43.

The end device 14 can be operatively connected to the central device 12 to transmit data thereto and receive data therefrom across the network 15. Accordingly, the end device 14 can be enabled for communication across the network 15. For instance, the end device 14 can further include a wireless transceiver 44. The discussion of the transceiver 20 presented in connection with the central device 12 is equally applicable to the transceiver 44 of the end device 14. The wireless transceiver 44 can be operatively connected to the processor 40, the memory 42 and/or the sensor 43. The transceiver 44 of the end device 14 can transmit to and receive data from the transceiver 20 of the central device 12 or the transceiver of any other component that can communicate with the central device 12. For security purposes, any transmission between the central device 12 and any of the end devices 14 can be encrypted.

It will be appreciated that, in at least in some instances, there may be a router 48 (FIG. 1) operatively positioned between one or more of the end devices 14 and the central device 12. The router 48 can be any component or group of components capable of directing signals on a network and may be considered part of the network 15. The router 48 can transmit data received from one or more of the end devices 14 to the central device 12. Alternatively or in addition, the router 48 can transmit data received from the central device 12 to the end devices 14. The end devices 14 may contain sufficient functionality to communicate with the central device 12 and/or the router 48, but—in some arrangements—not with any of the other end devices 14.

The end device 14 may include a power supply 46, which may be an internal source or external source. The power supply 46 can be an energy storage device, which can be any component or group of components capable of receiving and storing electrical energy for consumption. In one embodiment, the energy storage device can be a battery. Alternatively or in addition, the power supply 46 can be an electrical grid, that is, an interconnected network for delivering electrical energy to consumers. In such case, the power supply 46 can be, for example, an electrical outlet or wall socket. The end device 14 may have a user input interface 45 and/or an output system 47. The above discussion of the user input interface 24 and the output system 26 of the central device 12 can apply equally to the user input interface 45 and the output system 47 of the end device 14.

The central device 12 may also be operatively connected to a communication device 50 (FIG. 1) to transmit data thereto and receive data therefrom. To that end, the communication device 50 can include a transceiver 52. The communication device 50 can be any type of device, including, for example, a cellular telephone, a smart phone, a personal digital assistant (“PDA”), a tablet computer, a digital reader, a handheld device having wireless connection capability, a computer (e.g., a desktop computer, a laptop computer), a portable communication device, a portable computing device, an entertainment device (e.g., a music or video device, or game console), a set-top box or set-top unit (e.g. a cable or satellite box), a camera or any other suitable device that is configured to communicate via a wireless or wired medium, such as a network.

The central device 12 can be operatively connected to the communication device 50 in any suitable manner, including any of the ways mentioned herein. The central device 12 can be operatively connected to the communication device 50 in the same way that the central device 12 is operatively connected to the end devices 14. In such case, the transceiver 52 of the communication device 50 may be in communication with the transceiver 20 of the central device 12. Alternatively, the central device 12 may be operatively connected to the communication device 50 in a different way than the central device 12 is operatively connected to the end devices 14. In such case, the transceiver 52 of the communication device 50 can be in communication with the additional transceiver 22 of the central device 12.

The central device 12 can collect and display the status of all end devices 14 operatively connected thereto. The term “status” is defined as any information, parameter, event or condition associated with an end device, including with respect to its operation as a whole or with respect to individual components thereof. Examples of status can include whether the end device 14 is on or off, temperature, remaining battery life, whether the device is open or closed, locked or unlocked, sound level, whether one or more of the components or systems of the end device 14 are functioning normally or whether there is a problem or malfunction with one or more of the components or systems thereof. A user can configure the central device 12 and/or one or more of the end devices 14 to collect and/or display any status of interest associated with one or more of the end devices 14 and/or the central device 12. Alternatively or in addition, one or more of the end devices 14 may be preconfigured to report the one or more statuses of interest of the end device 14.

The central device 12 can be configured to notify a user of one or more particular statuses of interest. Notification can be provided in any suitable form. For instance, the output system 26 of the central device 12 can display the particular status of interest, activate a notification light, provide an audible alarm and/or provide a tactile alarm (such as vibration). Alternatively, the central device 12 can be configured to notify a user of one or more statuses of interest by way of the communication device 50, such as by an email message, a text message, a notification light, an audible alarm and/or a tactile alarm.

In some instances, the central device 12 and/or one or more of the end devices 14 can be configured to allow the central device 12 to command one or more aspects of the one or more end devices 14. Such commanding can occur based on preprogrammed instructions of the user or based on spontaneously inputted instructions from the user. Alternatively or in addition, such commanding may occur based on factory programmed instructions based on certain conditions (such as an overheating condition). In one embodiment, one or more aspects of an end device 14 can be adjusted if a specific status of interest occurs with respect to that particular end device 14. For instance, if a ceiling fan is reported as being on for more than a predetermined length of time, then the central device 12 can turn the ceiling fan off or reduce the speed of the fan to conserve energy. In other instances, one or more aspects of an end device 14 can be adjusted if a certain status of interest occurs with respect to a different end device 14.

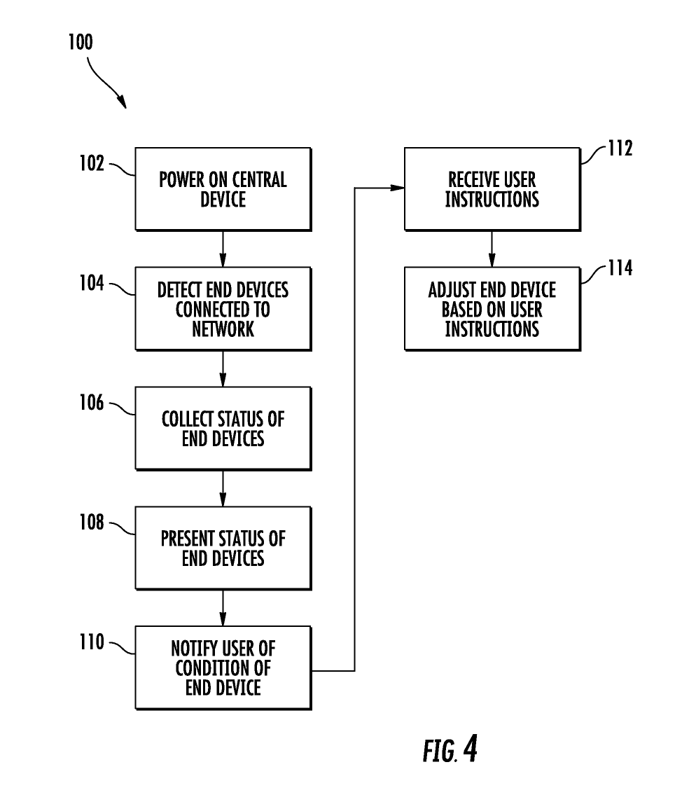

Now that various possible components of a system 10 have been described, one manner of the operation of the system 10 will now be described. The following description is merely provided as an example, and embodiments are not limited to the specific details and steps described. Referring to FIG. 4, an exemplary method 100 for operating the first system of monitoring and reporting network enabled devices is shown. At step 102, the central device 12 can be powered on. At step 104, the central device 104 can detect and/or identify all end devices 14 operatively connected thereto. Step 104 may be repeated continuously, periodically or randomly, as other end devices 14 may be added to the network. If a new end device 14 seeks to be added to the network 15, then the central device 12 can be adapted to grant or deny permission to the new end device 14 to join the network.

At step 106, the status of the one or more end devices 14 operatively connected to the central device 12 can be collected. Step 106 can be performed in any suitable manner. For instance, step 106 can comprise the central device 12 determining the status of each end device 14 by prompting each end device 14, which can send a response thereto. Alternatively or in addition, step 106 can comprise the one or more end devices 14 reporting their status to the central device 12 on their own, that is, without being prompted by the central device 12. Step 106 can be performed at any suitable time. For instance, step 106 can be performed continuously, periodically, or randomly. Alternatively or in addition, step 106 may be performed upon the occurrence of a predetermined status. Step 106 can be performed at substantially the same time for all end devices 14, or step 106 can be performed at a different time for one or more of the end devices 14. Conventional collision avoidance techniques can be employed here to minimize disruption of signal transmission.

At step 108, the status of the one or more end devices 14 can be presented to a user by the output system 26 of the central device 12. Such output may be in any suitable form. For instance, the status of the one or more end devices 14 can be presented visually, such as on a display of the central device 12, and/or audibly, such as by speakers of the central device 12, and/or in any other suitable manner, including those presented herein. In some instances, the status of the end devices 14 may not be presented unless a particular status of interest occurs, as predetermined by the manufacturer or user. In some instances, a manufacturer may configure the central device 12 and/or the end devices 14 to inform the user of particular conditions, such as safety hazards, regardless the user settings.

At step 110, if a condition of interest occurs, then the central device 12 can notify the user in any suitable manner, including in any of the ways discussed above. At step 112, the user can manage or adjust one or more of the end devices 14 in response to the notification. For example, the user can provide instructions on altering some aspect of one of the end devices 14 or its manner of operation by direct input into the central device 12 or indirectly by the portable communication device 50.

Such instructions may be pre-programmed into the central device 12 in which case the central device 12 can automatically make the desired adjustments at step 114. Alternatively, the user can input the instructions in response to a notification. In some embodiments, the user may be able to address the condition by instructions provided to the central device 12. For instance, an end device 14, such as a space heater, can be turned off if it is has remained on for more than a predetermined amount of time. However, in some instances, it may not be possible for the user to address the condition using the central device 12. For instance, if the central device 12 detects that a refrigerator door has been open for a certain amount of time, then the user may have to personally travel to the refrigerator to close the door, unless the refrigerator is configured to automatically close its door.

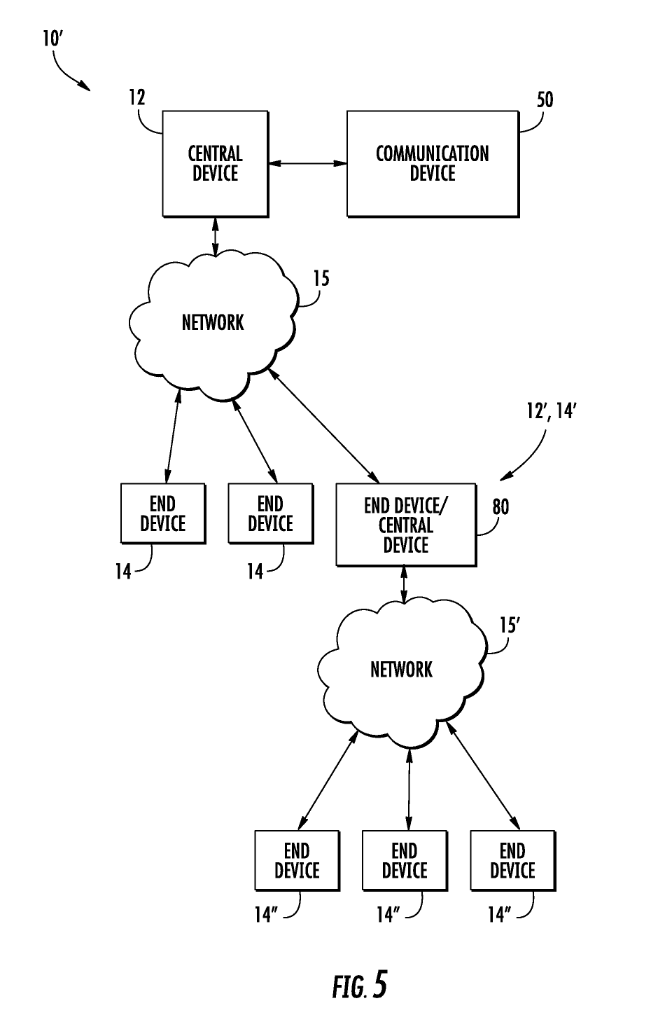

It will be appreciated that, in some instances, one or more of the end devices 14 can be the central device/coordinator of another network. FIG. 5 shows an example of such a system 10′. One of the end devices 14′ can be the central device 12′ and network coordinator of a separate network 15′. The network 15′ may be different from the network 15 in one or more respects. A plurality of end devices 14″ can be operatively connected to the end device 14′ by way of the network 15′. In one embodiment, the end device 14′ can be a smart meter 80.

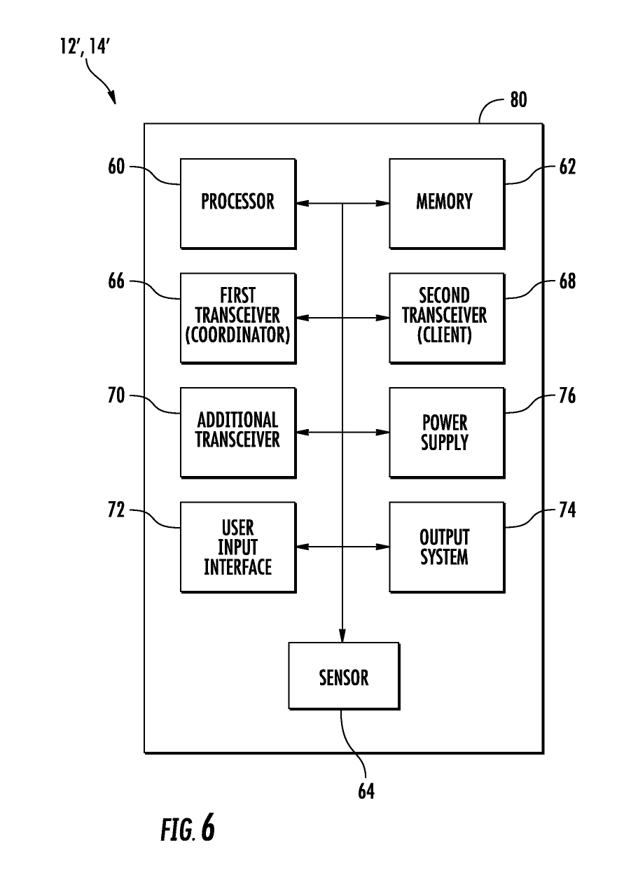

It may be desirable to include the end device 14′ and all end devices 14″ connected thereto in the system 10′. Accordingly, the end device 14′ can be configured to allow such a possibility. FIG. 6 shows an example of such an end device 14′. The end device 14′ can include a processor 60, memory 62, one or more sensors 64, a first transceiver 66, a second transceiver 68, an additional transceiver 70, a user input interface 72, an output system 74 and/or a power supply 76. The earlier discussion of similar components and their use in connection with the end device 14 can apply equally to end device 14′. Likewise, the earlier discussion of similar components and their use in connection with the central device 12 can apply to end device 14′ as well, as it is the central device 12′ of the separate network 15′.

It should be noted that the first transceiver 66 can be configured as a coordinator of the network 15′. The second transceiver 68 can be configured as a client to another coordinator. In this way, the end devices 14″ of the network 15′ can effectively join the network 15 in which case the central device 12 can be the coordinator of the end device 14′. While the system 10′ would include two separate networks 15, 15′, the system 10′ is structured such that the central device 12 can effectively monitor, manage and/or command the devices on both networks 15, 15′, including end device 14, end device 14′, and end devices 14″. Thus, it will be understood that the method 100 explained in connection with FIG. 4 above is equally applicable to the system 10′ of FIG. 5. If the user wishes to adjust one of the end devices 14″ associated with the separate network 15′, then the central device 12 can instruct the end device 14′ to execute the instructions.

Aspects and embodiments described herein can provide numerous benefits. With the systems and methods described herein, all end devices connected to a network can be monitored and managed from a single location—the central device. Moreover, a user can operate devices remotely from the central device, such as by a communication device. As a result, the user may no longer has to personally inspect each end device in person to determine the status of an end device. Moreover, it may be possible to detect any problems associated with the devices early, thereby potentially avoiding more serious problems if such problems are not timely addressed. Further, embodiments herein may be implemented in connection with existing network system, such as smart meters.

The flowchart and block diagrams in the figures illustrate the architecture, functionality, and operation of possible implementations of systems, methods and computer program products according to various embodiments of the aspects and embodiments herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Aspects and embodiments herein can be realized in hardware, software, or a combination of hardware and software. Aspects and embodiments herein can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. Aspects and embodiments herein also can be embedded in a computer-readable storage, such as a computer program product or other data programs storage device, readable by a machine, tangibly embodying a program of instructions executable by the machine to perform methods and processes described herein. Aspects and embodiments herein also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects and embodiments herein can be embodied in other forms without departing from the spirit or essential attributes thereof. Accordingly, reference should be made to the following claims, rather than to the foregoing specification, as indicating the scope of the invention.

What is claimed is:

1. A system for monitoring and managing a network of electrical devices comprising:
a central device; and
a first plurality of end devices being operatively connected to the central device, the end devices being electrical devices, the central device being configured to monitor the status of the first plurality of end devices, the central device being further configured to remotely adjust at least one aspect of at least one of the first plurality of end devices.

2. The system of claim 1 further including a communication device, wherein the central device is operatively connected to transmit notifications to the communication device, whereby a user is notified of a status of at least one of the first plurality of end devices.

3. The system of claim 2, wherein the communication device is operatively connected to transmit instructions to the central device, whereby the user can adjust an aspect of the end device in response to the notification.

4. The system of claim 2, wherein the communication device is one of a cellular telephone, a smart phone, a personal digital assistant, a tablet computer, a digital reader, a handheld device having wireless connection capability, a computer, a portable communication device, a portable computing device, an entertainment device or a camera.

5. The system of claim 1, wherein the central device is configured to adjust one of the first plurality of end devices upon the occurrence of a particular status associated with the one of the first plurality of end devices.

6. The system of claim 1, wherein the central device is configured to adjust one of the first plurality of end devices upon the occurrence of a condition associated with another one of the first plurality of end devices.

7. The system of claim 1, wherein the first network is a ZigBee network.

8. The system of claim 1, wherein the central device is configured to prompt the first plurality of end devices, and wherein the first plurality of end devices reports to the central device in response to the prompts.

9. The system of claim 1, wherein one of the first plurality of end devices is a second central device that is operatively connected to a second plurality of end devices, wherein the second central device is configured to monitor the status of the second plurality of end devices and to report to the first central device, wherein the first central device is configured to (a) remotely monitor the second plurality of end devices or (b) remotely command one or more aspects of at least one of the second plurality of end devices.

10. The system of claim 9, wherein the second central device is a smart meter.

11. A method of monitoring and managing a first plurality of end devices operatively connected to a central device, the central device including a processor and a transceiver for communicating with the first plurality of end devices, the central device including an output system, the method comprising the steps of:
via the central device, collecting the status of each of the first plurality of end devices; and
presenting the status of each of the first plurality of end devices to a user on the output system.

12. The method of claim 11, further including the step of:
notifying a user of a condition of at least one of the first plurality of end devices.

13. The method of claim 12, wherein the notifying step comprises transmitting a notification to a communication device operatively connected to the central device.

14. The method of claim 11, further including the steps of adjusting one of the first plurality of end devices based on the condition of the one of the first plurality of end devices.

15. The method of claim 11, further including the steps of adjusting one of the first plurality of end devices based on the condition of a different one of the first plurality of end devices.

16. The method of claim 11, wherein the determining step is performed on a continuous basis or a periodic basis.

17. The method of claim 11, further including the steps of:
via the end devices, automatically reporting the status of each device to the central device.

18. The method of claim 11, further including the steps of:
via the central device, prompting the end devices for a status; and
via the end devices, reporting the status of each device to the central device in response to the prompting step.

19. The method of claim 11, wherein one of the first plurality of end devices is a second central device that is operatively connected to a second plurality of end devices by a second network, wherein the second central device is configured to monitor the status of the second plurality of end devices and to report to the first central device.

20. The method of claim 19, wherein the first central device is configured to command an aspect the second central device, and further including the step of commanding one of the second plurality of end devices based on an instruction received in the first central device.
